(19) United States
(12) Patent Application Publication
(10) Pub. No.: US 2014/0006333 A1
(43) Pub. Date: Jan. 2, 2014

(54) CORRECTING INFERRED KNOWLEDGE FOR EXPIRED EXPLICIT KNOWLEDGE

(71) Applicant: Ontotext AD, Sofia (BG)

(72) Inventors: Damyan Ognyanov, Sofia (BG); Ruslan Velkov, Sofia (BG)

(21) Appl. No.: 13/924,209

(22) Filed: Jun. 21, 2013

Related U.S. Application Data
(60) Provisional application No. 61/662,685, filed on Jun. 21, 2012.

(51) Int. Cl. G06N 5/04

(52) U.S. Cl. CPC G06N 5/04
USPC 706/51

(57) ABSTRACT

An RDF reason maintenance system avoids imposing a scalability restriction on the number of explicit statements stored in RDF databases. The system can identify those inferred statements that suitably should be removed whenever an explicit statement is deleted (retracted). The system dynamically computes the truth using a combination of the forward-chaining hardware and the backward-chaining hardware. The system is time-efficient, computes faster than a full re-computation, and need not use any long-lived truth maintenance information (space-efficient).

### CROSS-REFERENCE TO RELATED APPLICATION

This application claims the benefit of Provisional Application No. 61/662,685, filed Jun. 21, 2012, which is incorporated herein by reference.

### TECHNICAL FIELD

The present subject matter generally relates to computing, and more particularly, relates to reason maintenance systems or belief revision systems.

### BACKGROUND

An ontological database uses Resource Description Framework (RDF), Resource Description Framework Schema (RDFS), and Web Ontology Language (which has come to be known as OWL). RDF is a notion that any knowledge can be represented as a tuple or statement expressing a collection of resources, such as a subject, predicate, and object. While RDF does not impose any limits for the subjects, predicates, and objects, RDFS adds rules to constrain the values of the subjects, predicates, and objects to certain domains and ranges. After RDFS was introduced, it was felt there was a need for patterns of knowledge to be expressed as rules. OWL was developed to allow knowledge to be inferred from an explicit set of RDF information using inference rules, which further restricts the values of subjects, predicates, and objects. Because inferred knowledge is dependent on explicit knowledge, falsities in inferred knowledge come into existence when the explicit knowledge expires or is deleted. Thus, there is a need to compute the truth of inferred knowledge and restore consistency.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect includes a system form of the present subject matter which recites a system of hardware for implementing reason maintenance. The system comprises a piece of reasoner hardware whose structure has a capacity to communicate with a piece of inferred knowledge hardware and whose structure has a capacity to compute RDF inferred statements. The system further comprises a piece of reason maintenance hardware whose structure is capable of orchestrating a computation of correctness of the RDF inferred statements without stored truth maintenance information when one or more RDF explicit statements are deleted from an RDF database.

Another aspect includes a method form of the present subject matter which recites a method for reason maintenance of an RDF database. The method comprises receiving explicit statements including a set of deleted explicit statements. The method also comprises computing inferred statements from the explicit statements. The method further comprises finding a set of inferred statements to be deleted from the inferred statements to facilitate correctness of the inferred statements without using stored truth maintenance information.

A further aspect includes a computer-readable medium form of the present subject matter which recites a computer-readable medium, which is non-transitory, having computer-executable instructions stored thereon for implementing a method for reason maintenance of an RDF database. The method comprises receiving explicit statements including a set of deleted explicit statements. The method also comprises computing inferred statements from the explicit statements. The method further comprises finding a set of inferred statements to be deleted from the inferred statements to facilitate correctness of the inferred statements without using stored truth maintenance information.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating archetypical pieces of hardware suitable for computing the truth of inferred knowledge when explicit knowledge expires or is deleted without the use of truth maintenance information in accordance with one embodiment of the present subject matter;

FIG. 2 is a pictorial diagram illustrating an archetypical data structure that contains explicit knowledge in the form of RDF explicit statements in accordance with one embodiment of the present subject matter;

FIG. 3 is a pictorial diagram illustrating an archetypical data structure that contains inference rules for inferring RDF inferred knowledge in accordance with one embodiment of the present subject matter;

FIG. 4 is a pictorial diagram illustrating an archetypical data structure that contains statements which act as input queries to an RDF database in accordance with one embodiment of the present subject matter;

FIG. 5 is pictorial diagram illustrating an archetypical data structure that contains identified RDF statements in accordance with one embodiment of the present subject matter; and

FIGS. 6A-6H are process diagrams illustrating a method for facilitating correctness of inferred knowledge without truth maintenance information when explicit knowledge expires or is deleted in accordance with one embodiment of the present subject matter.

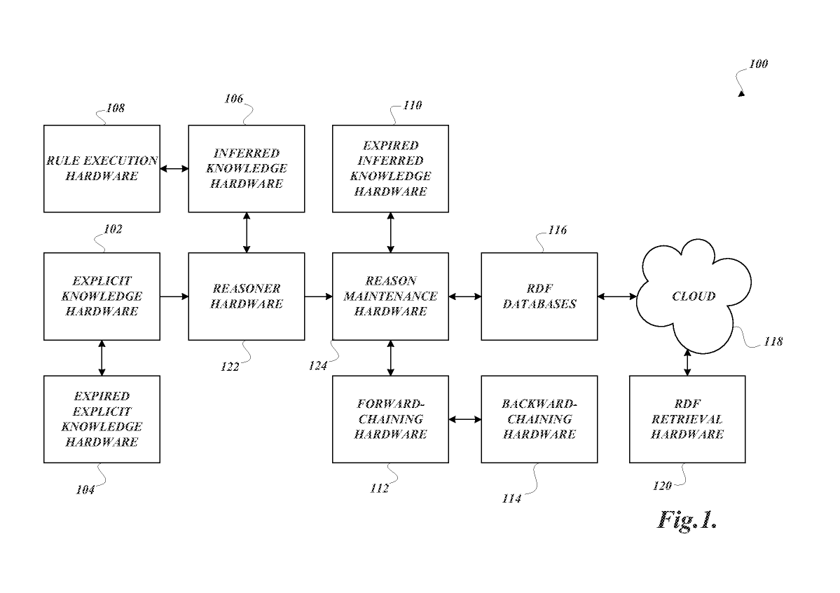

### DETAILED DESCRIPTION

Various embodiments of the present subject matter are engineered to maintain inferred closure of RDF data in the context of incremental retraction of asserted statements. A few embodiments of the present subject matter are engineered to compute the truth value of inferred knowledge in the form of RDF statements and restore consistency of the inferred knowledge. A number of embodiments of the present subject matter are engineered to facilitate correctness of the inferred knowledge without truth maintenance information when explicit knowledge expires or is deleted.

A system 100 is a database management system for RDF which is suitable to infer information (implicit data or derived data or inferred data or derived information) that is derived from user data (explicit data) and a set of inference rules. The system 100 computes derived data in a number of ways. The system 100 may actuate a forward-chaining hardware 112 whose structure computes the derived information whenever the explicit data changes. In this case, the set of inference rules are applied to the explicit data to compute the inferred data. Any new inferred data found this way is reused as input to rule-evaluation until no more derived information can be derived. Another way to compute derived data is to actuate a backward-chaining hardware 114 by the system 100, where the derived information is computed as needed when RDF databases 116 are accessed (query-answering). In this case, the set of inference rules are examined to determine which of them might produce results that satisfy the query and the bodies of the set of inference rules are substituted into the query expression and re-evaluated recursively.

When a conventional database management system for RDF, which is different from the system 100, uses only forward-chaining, maintaining the correctness of the inferred data when explicit data is modified is difficult because either it is entirely recomputed (computationally expensive) or it is updated incrementally. In the former case, the time taken is excessive when dealing with large datasets, and in the latter case, this is often achieved by keeping track of which statements lead to each inferred statement, a process called “truth maintenance”. Using a “truth maintenance” technique, removing an explicit statement entails a look-up of which inferred statements to remove. However, the amount of truth maintenance information grows faster than the size of the explicit data, which makes it impractical for large datasets. In contrast, the system 100 is capable of forward-chaining inference, but its pieces of hardware maintain the correctness of inferred information without the need to re-compute all inferred information when any explicit data is deleted and without the need to keep truth maintenance information.

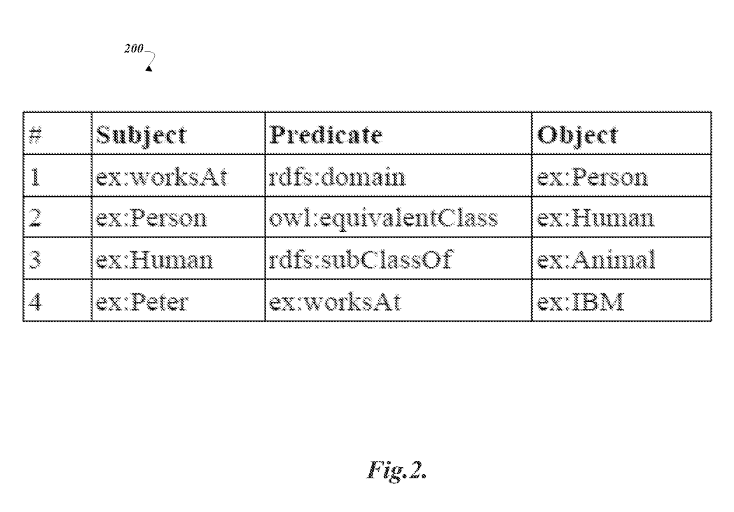

Consider the following example. FIG. 2 illustrates a matrix 200 that contains explicit knowledge in the form of RDF explicit statements. There are four columns, the first column identifying an identifier (numerical) of an explicit statement, the second column indicating the subject of the explicit statement, the third column indicating the predicate, and the last column indicating the object. The first row recites a first explicit statement, whose identifier is “1”, whose subject is recited as “ex:worksAt,” whose predicate is recited as “rdfs:doman,” and whose object is recited as “ex:Person.” The second row recites a second explicit statement whose identifier is “2”, whose subject is recited as “ex:Person,” whose predicate is recited as “owl:equivalentClass,” and whose object is recited as “ex:Human.” The third row recites a third explicit statement whose identifier is “3”, whose subject is recited as “ex:Human,” whose predicate is recited as “rdfs:subClassOf,” and whose object is recited as “ex:Animal.” The fourth row recites a fourth explicit statement whose identifier is “4”, whose subject is recited as “ex:Peter,” whose predicate is recited as “ex:worksAt,” and whose object is recited as “ex:IBM.”

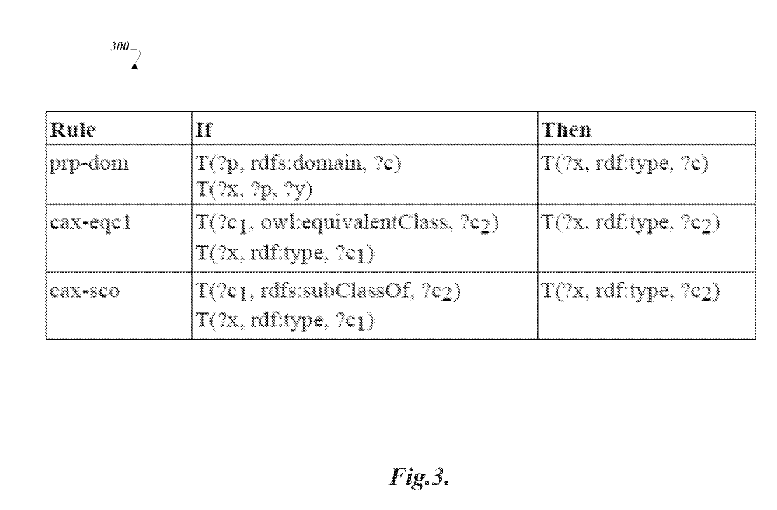

When the explicit statements of the matrix 200 are stored in an RDF database, such as various RDF databases 116, queries to the RDF databases 116 will return results based on the explicit statements of the matrix 200 as well as inferred statements computed by applying the set of inference rules to the explicit statements of the matrix 200. There can be many inference rules, but for the sake of simplicity, consider a set of inference rules illustrated by a matrix 300. FIG. 3 illustrates the matrix 300 comprising three columns and three rows. The first column recites the name of an inference rule. The second column recites an “If” test. And the third column recites an action following the execution of the “If” test, which in this instance is titled “Then.” The first row recites the first inference rule whose name is “prp-dom,” whose tests include “T(?p, rdfs:domain, ?c)” and “(T(?x, ?p, ?y),” and whose action recites “T(?x, rdf:type, ?c).” The second row recites the second inference rule whose name is “cax-eqc1,” whose tests include “(T(?c₁, owl:equivalentClass, ?c₂)” and “T(?x, rdf:type, ?c₁),” and whose action recites “T(?x, rdf:type, ?c₂).” The third row recites the third inference rule whose name is “cax-sco,” whose tests include “(T(?c₁, rdfs:subClassOf, ?c₂)” and “T(?x, rdf:type, ?c₁),” and whose action recites “T(?x, rdf:type, ?c₁).”

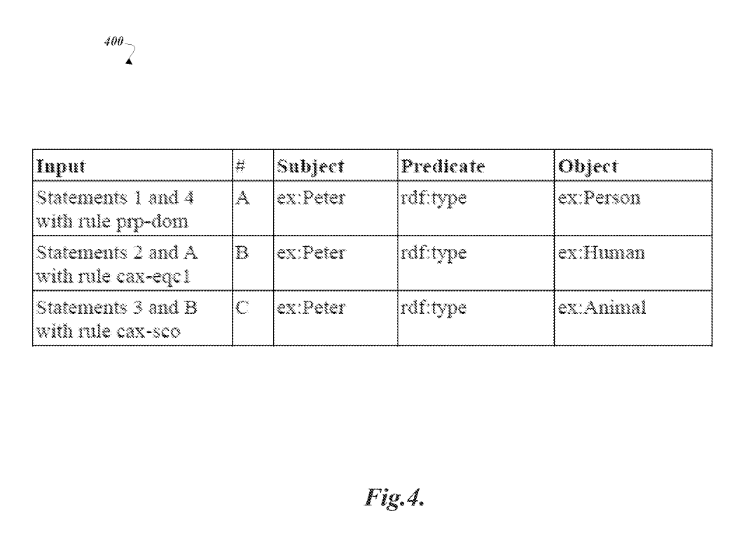

The system 100 uses the inference rules of the matrix 300 to compute inferred statements illustrated in a matrix 400. FIG. 4 illustrates the matrix 400, which recites computed inferred statements in five columns and three rows. The first column is titled “Input,” and contains explicit statements and inference rules to be applied to produce an inferred statement that is contained in the last three columns. The second column is titled “#”, and identifies textually the nomenclature of a computed inferred statement. The third column is titled “Subject,” and comprises a portion of a tuple of an RDF statement that is the computed inferred statement. The fourth column is titled “Predicate,” and signifies the predicate of the computed inferred statement. The last column is titled “Object,” and indicates the object portion of the computed inferred statement. The first row recites a first computed inferred statement whose input includes “Statements 1 and 4 with rule prp-dom,” whose nomenclature is “A”, whose subject, predicate, and object are recited as “ex:Peter,” “rdf:type,” and “ex:Person.” The second row recites a second computed inferred statement whose input includes “Statements 2 and A with rule cax-eqc1,” whose nomenclature is “B”, and whose subject, predicate, and object are recited as “ex:Peter,” “rdf:type,” and “ex:Human.” The third row recites a third computed inferred statement whose input includes “Statements 3 and B with rule prp-dom,” whose nomenclature is “C”, and whose subject, predicate, and object are recited as “ex:Peter,” “rdf:type,” and “ex:Animal.”

Even with this simple example, it is not immediately clear, using pencil and paper, the reasons that statement C “ex:Peter rdf:type ex:Animal” should be inferred. If any of the explicit statements of the matrix 200 used as input are removed from the RDF databases 116, a computation question for the system 100 is which of the inferred statements A-C of the matrix 400 should be removed when any of the explicit statements 1-4 of the matrix 200 are deleted. The quick answer is that the inferred statement C should no longer hold true, computationally, and the query-answering process should not use statement C as input. More specifically, suppose that the explicit statement 2 “ex:Person owl:equivalentClass ex:Human” is deleted; the computation question is then which of the inferred statements A-C should be removed. The quick answer is that the inferred statements B “ex:Peter rdf:type ex:Human” and C “ex:Peter rdf:type ex:Animal” suitably also should be removed. The following pieces of hardware and/or software elucidate this truth computation of inferred knowledge by the system 100 and/or the processes of a method 6000.

The system 100 avoids imposing a scalability restriction on the number of explicit statements stored in the RDF databases 116. The system 100 can identify those inferred statements that suitably should be removed whenever an explicit statement is deleted (retracted). The system 100 dynamically computes the truth using a combination of the forward-chaining hardware 112 and the backward-chaining hardware 114. The system 100 is time-efficient, computes faster than a full re-computation, and need not use any long-lived truth maintenance information (space-efficient).

The system 100 includes an explicit knowledge hardware 102 whose structure is suitable for receiving explicit knowledge (explicit data or user data) in a form of explicit statements in RDF format. (See the matrix 200 of FIG. 2). The explicit knowledge hardware 102 is communicable with an expired explicit knowledge hardware 104 whose structure is capable of receiving explicit statements that have expired or are to be deleted or retracted. The explicit knowledge hardware 102 forwards explicit knowledge in the form of explicit statements to a piece of reasoner hardware 122, whose structure has a capacity to communicate with a piece of inferred knowledge hardware 106. The inferred knowledge hardware 106 is a piece of hardware whose structure has a capacity to compute inferred knowledge (implicit data or derived data) as inferred statements in RDF using a piece of rule execution hardware 108. The rule execution hardware 108 is a structure suitable for executing a set of inference rules (see the matrix 300 of FIG. 3) on the explicit statements to produce inferred knowledge in the form of inferred statements. The inferred knowledge hardware 106 is communicable with a piece of expired inferred knowledge hardware 110 whose structure is capable of computing expired inferred knowledge in the form of expired inferred statements (see the matrix 400 of FIG. 4). The structure of the reasoner hardware 122 is suitable for communicating with a piece of reason maintenance hardware 124 whose structure is capable of orchestrating the computation of the truth or correctness of the inferred statements. The structure of the reason maintenance hardware 124 is communicable with a piece of expired inferred knowledge hardware 110 which uses a piece of forward-chaining hardware 112 whose structure has the capacity to execute forward-chaining inferences. The structure of the expired inferred knowledge hardware 110 is also communicable with a piece of backward-chaining hardware 114 whose structure is capable of computing backward-chaining inferences. The structure of the reason maintenance hardware 124 is communicable with one or more RDF databases 116 to remove expired inferred statements stored in the RDF databases 116 when certain explicit statements are expired or are to be deleted or retracted. A piece of RDF retrieval hardware 120 accesses refreshed RDF information in the RDF databases 116 via a cloud 118.

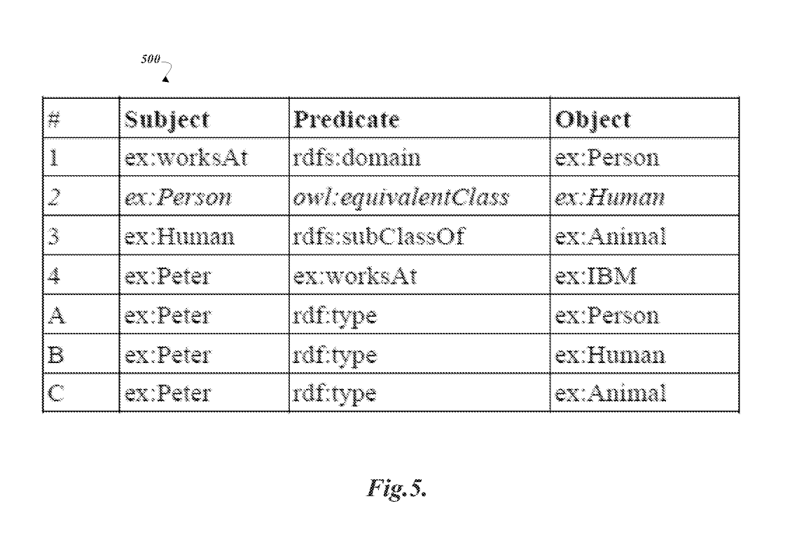

FIG. 5 illustrates a matrix 500 that contains both the explicit statements and the computed inferred statements stored in the RDF databases 116. The matrix 500 is presented in four columns. The first column is titled “#”, and recites either numerically or textually an identifier of an explicit or inferred statement that follows on a row. The second column is titled “Subject,” and recites the subject of either the explicit or inferred statement. The third column is titled “Predicate,” and recites the predicate portion of either the explicit or inferred statement. The last column is titled “Object,” and recites the object portion of the inferred or explicit statement. The first row recites an explicit statement whose identifier is “1”, whose subject is “ex:worksAt,” whose predicate is recited as “rdfs:domain,” and whose object is recited as “ex:Person.” The second row recites an explicit statement whose identifier is “2”, whose subject is “ex:Person,” whose predicate is recited as “owl:equivalentClass,” and whose object is recited as “ex:Human.” The third row recites an explicit statement whose identifier is “3”, whose subject is “ex:Human,” whose predicate is recited as “rdfs:subClassOf,” and whose object is recited as “ex:Animal.” The fourth row recites an explicit statement whose identifier is “4”, whose subject is “ex:Peter,” whose predicate is recited as “ex:worksAt,” and whose object is recited as “ex:IBM.” The fifth row recites an inferred statement whose identifier is “A”, whose subject is “ex:Peter,” whose predicate is recited as “rdf:type,” and whose object is recited as “ex:Person.” The sixth row recites an inferred statement whose identifier is “B”, whose subject is “ex:Peter,” whose predicate is recited as “rdf:type,” and whose object is recited as “ex:Human.” The seventh row recites an inferred statement whose identifier is “C”, whose subject is “ex:Peter,” whose predicate is recited as “rdf:type,” and whose object is recited as “ex:Animal.”

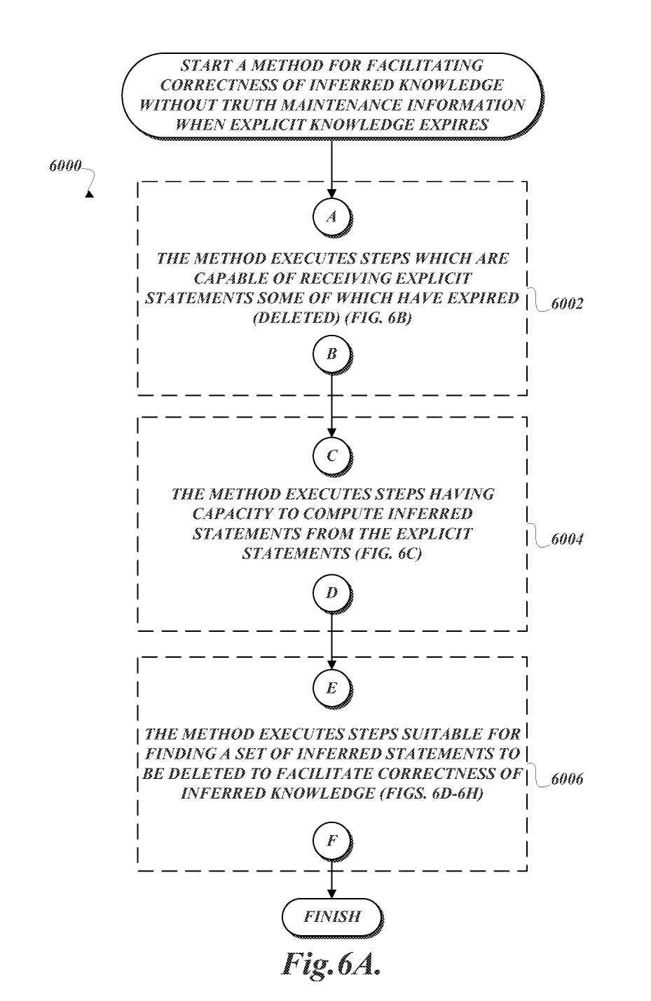

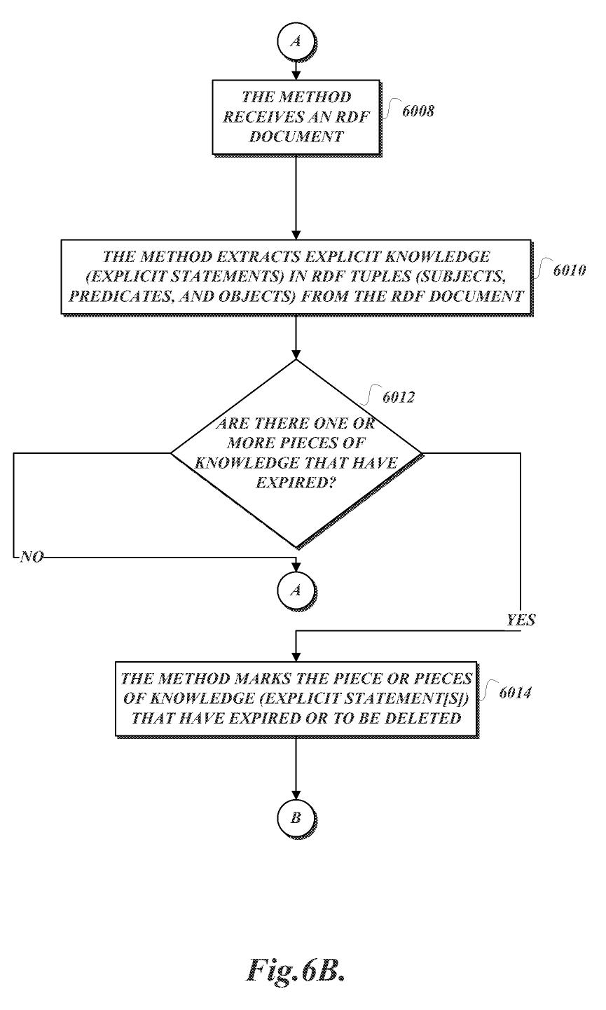

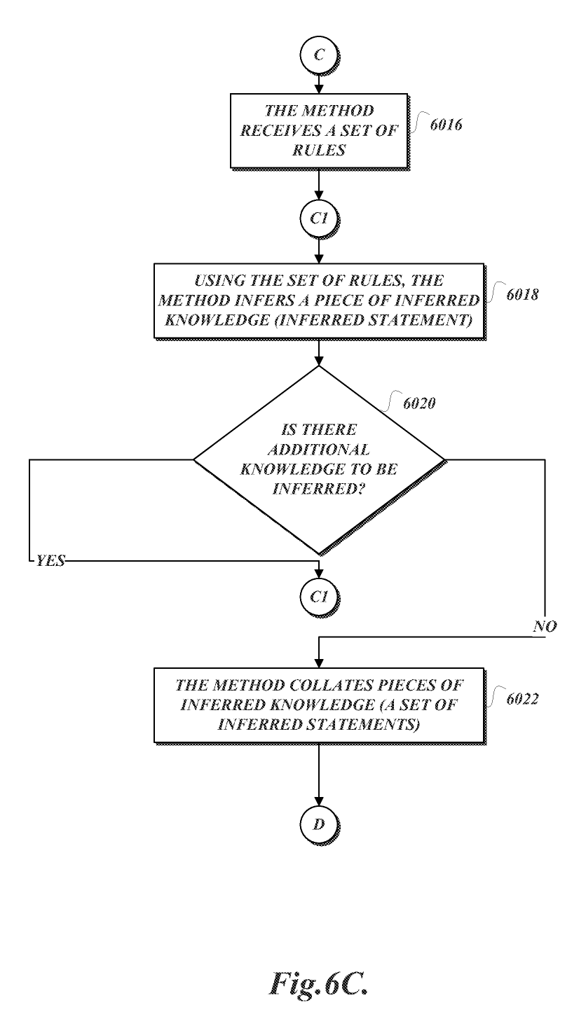

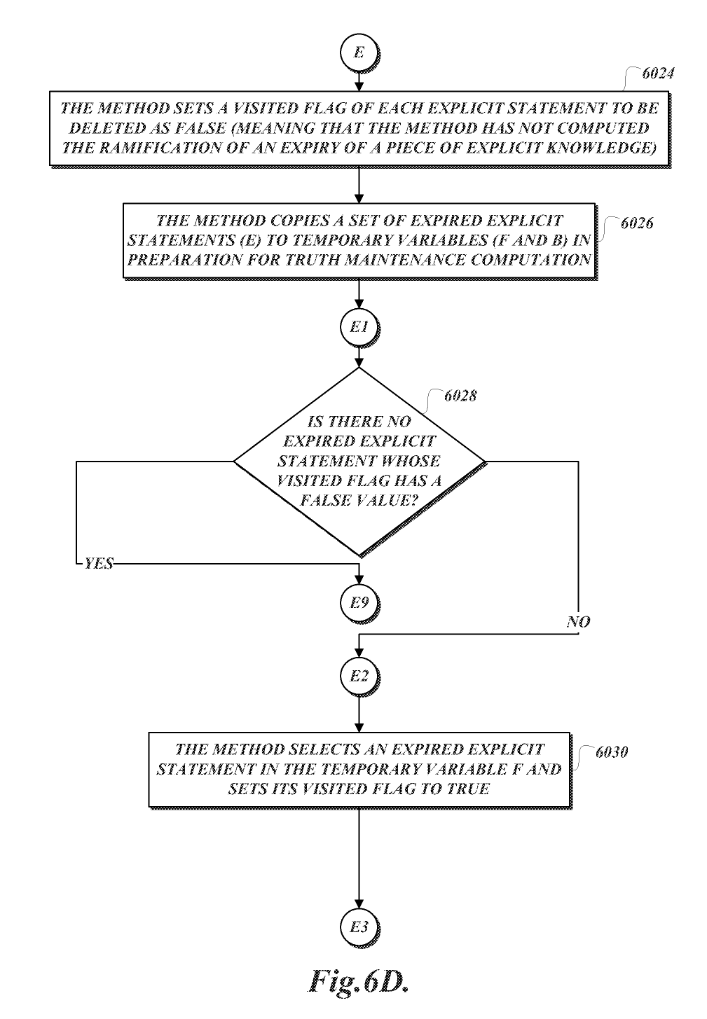

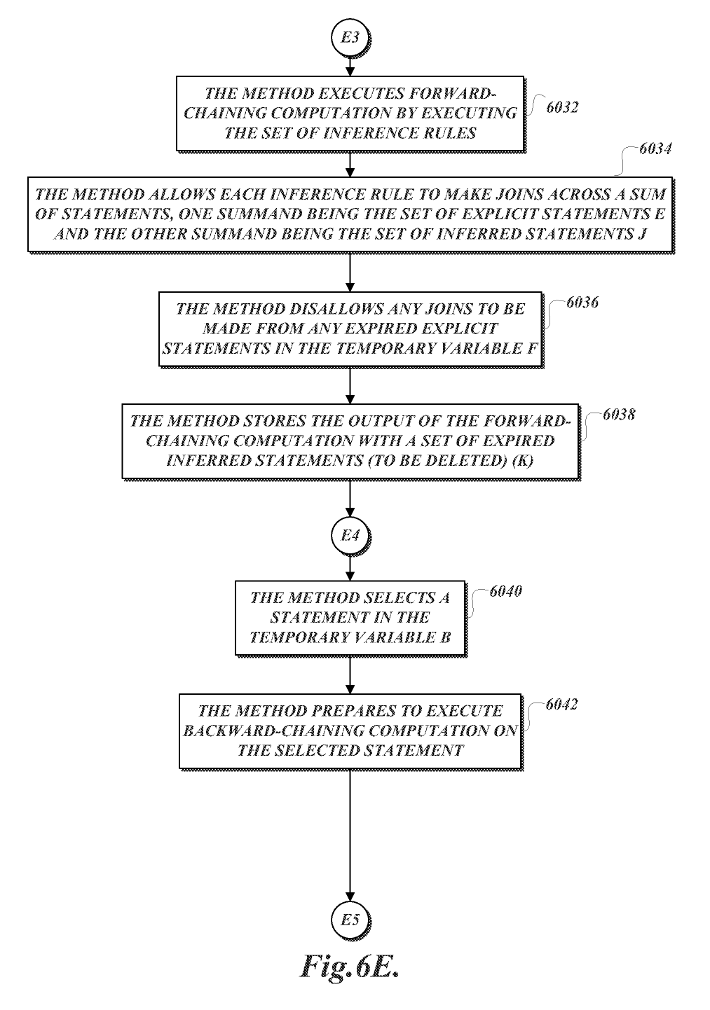

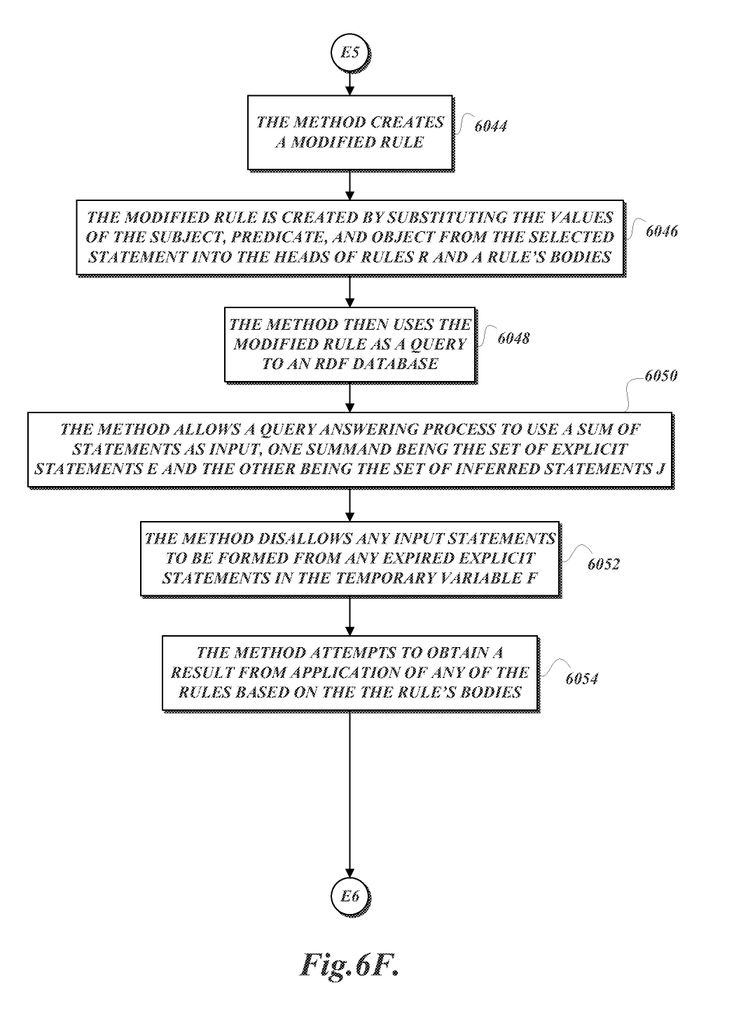

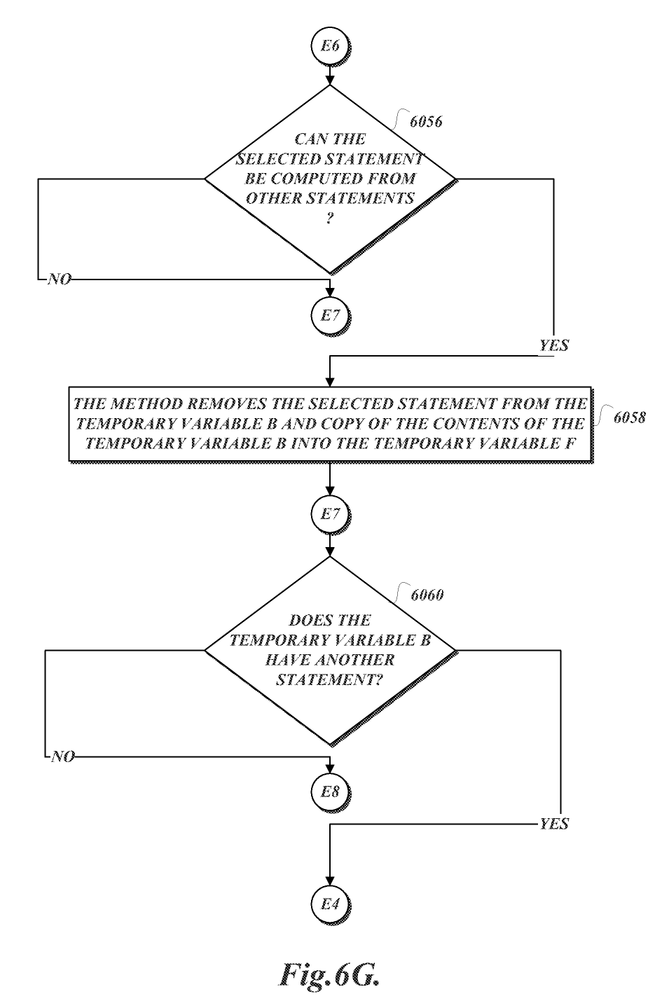

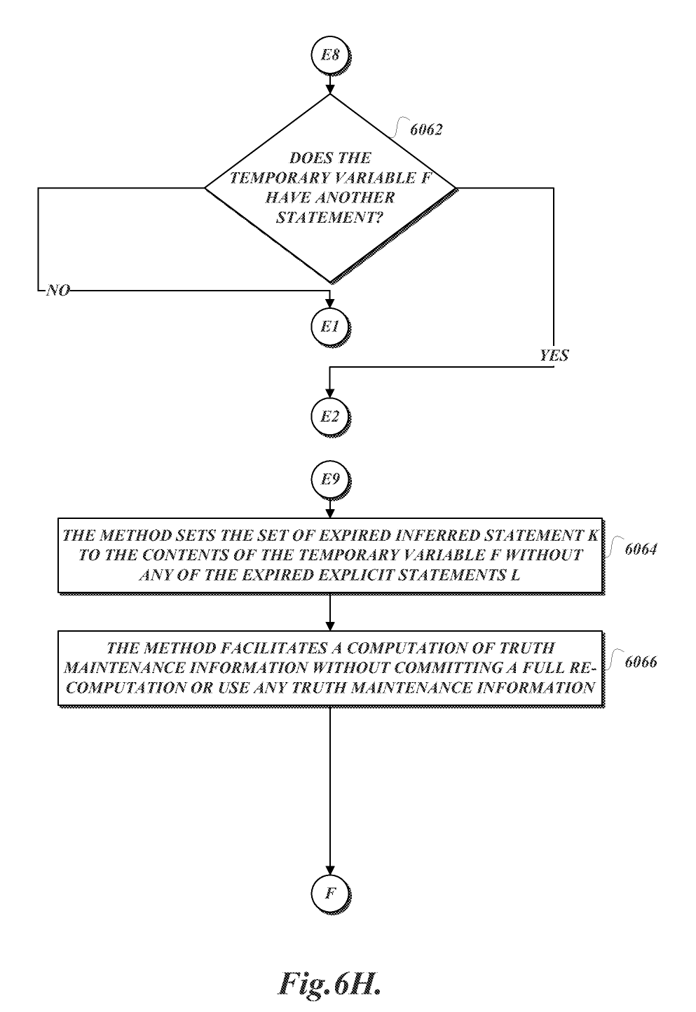

FIGS. 6A-6H are process diagrams implementing a method 6000 for facilitating correctness of inferred knowledge without stored truth maintenance information when explicit knowledge expires. From a start block, the method 6000 proceeds to a set of method steps 6002 defined between a continuation terminal (“Terminal A”) and another continuation terminal (“Terminal B”). The set of method steps 6002 executes steps which are capable of receiving explicit statements some of which have expired (or been deleted). From Terminal A (FIG. 6B), the method proceeds to block 6008 where the method receives an RDF document. At block 6010, the method extracts explicit knowledge (explicit statements) in RDF tuples (subjects, predicates, and objects) from the RDF document. Next, at decision block 6012, a test is performed to determine whether there are one or more pieces of knowledge that have expired. If the answer to the test at decision block 6012 is NO, the method proceeds to Terminal A and skips back to block 6008 where the above-identified processing steps are repeated. If the answer to the test at decision block 6012 is YES, the method proceeds to block 6014 where the method marks the piece or pieces of knowledge (explicit statement[s]) that have expired or are to be deleted. The method then continues to Terminal B.

From Terminal B (FIG. 6A), the method proceeds to a set of method steps 6004 defined between a continuation terminal (“Terminal C”) and another continuation terminal (“Terminal D”). The set of method steps 6004 executes steps having a capacity to compute inferred statements from the explicit statements. From Terminal C (FIG. 6C), the method proceeds to block 6016 where the method receives a set of inference rules. The method then continues to another continuation terminal (“Terminal C1”) and further proceeds to block 6018 where, using the set of inference rules, the method infers a piece of inferred knowledge (inferred statement). The method then proceeds to decision block 6020 where a test is performed to determine whether there is additional knowledge to be inferred. If the answer to the test at decision block 6020 is YES, the method continues to Terminal C1 and skips back to block 6018 where the above-identified processing steps are repeated. Otherwise, if the answer to the test at decision block 6020 is NO, the method proceeds to block 6022 where the method collates pieces of inferred knowledge (as a set or sets of inferred statements). The method then continues to Terminal D.

From Terminal D (FIG. 6A), the method proceeds to a set of method steps 6006 defined between a continuation terminal (“Terminal E”) and another continuation terminal (“Terminal F”). The set of method steps 6006 executes steps suitable for finding a set of inferred statements to be deleted to facilitate correctness of the inferred knowledge. From Terminal E (FIG. 6D), the method proceeds to block 6024 where the method sets a visited flag of each explicit statement to be deleted as false (meaning that the method has not computed the ramification of an expiry of a piece of explicit knowledge). At block 6026, the method copies a set of expired explicit statements (E) to temporary variables (F and B) in preparation for truth maintenance computation. The method then continues to another continuation terminal (“Terminal E1”). The method proceeds further to decision block 6028 where a test is performed to determine whether there is no expired explicit statement whose visited flag has a false value. If the answer to the test at decision block 6028 is YES, the method continues to another continuation terminal (“Terminal E9”). Otherwise, if the answer to the test at decision block 6028 is NO, the method proceeds to another continuation terminal (“Terminal E2”). From Terminal E2 (FIG. 6D), the method proceeds to block 6030 where the method selects an expired explicit statement in the temporary variable F and sets its visited flag to be true. The method then continues to another continuation terminal (“Terminal E3”).

From Terminal E3 (FIG. 6E), the method proceeds to block 6032 where the method executes forward-chaining computation by executing the set of inference rules. At block 6034, the method allows each inference rule to make joins across a sum of statements, one summand being the set of explicit statements E and the other summand being the set of inferred statements J. At block 6036, the method disallows any joins to be made from any expired explicit statements in the temporary variable F. At block 6038, the method stores the output of the forward-chaining computation with a set of expired inferred statements (to be deleted) (K). The method then continues to another continuation terminal (“Terminal E4”). From Terminal E4 (FIG. 6E), the method proceeds to block 6040 where the method selects a statement in the temporary variable B. At block 6042, the method prepares to execute backward-chaining computation on the selected statement. The method then continues to another continuation terminal (“Terminal E5”).

From Terminal E5 (FIG. 6F), the method proceeds to block 6044 where the method creates a modified rule. At block 6046, the modified rule is created by substituting the values of the subject, predicate, and object from the selected statement into the heads of rules R and a rule's bodies (or rules' bodies). At block 6048, the method then uses the modified rule as a query to an RDF database. At block 6050, the method allows a query answering process to use a sum of statements as input, one summand being the set of explicit statements E and the other being the set of inferred statements J. At block 6052, the method disallows any input statements to be formed from any expired explicit statements in the temporary variable F. At block 6054, the method attempts to obtain a result from application of any of the rules based on the rule's bodies. The method then continues to another continuation terminal (“Terminal E6”).

From Terminal E6 (FIG. 6G), the method proceeds to a decision block 6056 where a test is performed to determine whether the selected statement can be computed from other statements. If the answer to the test at decision block 6056 is NO, the method continues to another continuation terminal (“Terminal E7”). Otherwise, if the answer to the test at decision block 6056 is YES, the method proceeds to block 6058, where the method removes the selected statement from the temporary variable B and copies the contents of the temporary variable B into the temporary variable F. The method then continues to Terminal E7 and further proceeds to decision block 6060 where a test is performed to determine whether the temporary variable B has another statement. If the answer to the test at decision block 6060 is NO, the method proceeds to another continuation terminal (“Terminal E8”). Otherwise, if the answer to the test at decision block 6060 is YES, the method proceeds to Terminal E4 and skips back to block 6040 where the above-identified processing steps are repeated.

From Terminal E8 (FIG. 6H), the method proceeds to decision block 6062 where a test is performed to determine whether the temporary variable F has another statement. If the answer to the test at decision block 6062 is NO, the method proceeds to Terminal E1 and skips back to decision block 6028 where the above-identified processing steps are repeated. Otherwise, if the answer to the test at decision block 6062 is YES, the method proceeds to Terminal E2 and skips back to block 6030 where the above-identified processing steps are repeated. From Terminal E9 (FIG. 6H), the method proceeds to block 6064 where the method sets the set of expired inferred statement K to the contents of the temporary variable F without any of the expired explicit statements L. At block 6066, the method facilitates a computation of truth maintenance information without committing a full re-computation or using any truth maintenance information. The method then continues to Terminal F and terminates execution.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system of hardware for implementing reason maintenance, comprising:
a piece of reasoner hardware which structure has a capacity to communicate with a piece of inferred knowledge hardware and which structure has a capacity to compute RDF inferred statements; and
a piece of reason maintenance hardware which structure is capable of orchestrating computation of correctness of the RDF inferred statements without stored truth maintenance information when one or more RDF explicit statements are deleted from an RDF database.

2. The system of claim 1, further comprising a piece of explicit knowledge hardware whose structure is suitable for receiving the one or more RDF explicit statements deleted and which is further capable of communicating with the reasoner hardware.

3. The system of claim 2, further comprising a piece of expired explicit hardware which structure is capable of receiving explicit statements that are to be deleted and which is further capable of communicating with the explicit knowledge hardware.

4. The system of claim 1, further comprising a piece of rule execution hardware which structure is suitable for executing a set of inference rules on the one or more RDF explicit statements to compute the RDF inferred statements.

5. The system of claim 1, further comprising a piece of expired inferred knowledge hardware which structure is capable of computing expired inferred statements and is further capable of communicating with the reason maintenance hardware.

6. The system of claim 1, further comprising a piece of forward-chaining hardware which structure has a capacity to execute forward-chaining inferences and which is further capable of communicating with the reason maintenance hardware.

7. The system of claim 1, further comprising a piece of backward-chaining hardware which structure has a capacity to execute backward-chaining inferences and which is further capable of communicating with forward-chaining hardware.

8. A method for reason maintenance of an RDF database, comprising:
receiving explicit statements including a set of deleted explicit statements;
computing inferred statements from the explicit statements; and
finding a set of inferred statements to be deleted from the inferred statements to facilitate correctness of the inferred statements without using stored truth maintenance information.

9. The method of claim 8, further comprising copying the set of deleted explicit statements into a first and second temporary variable.

10. The method of claim 9, further comprising executing forward-chaining inferences using a set of inference rules to make joins across the explicit statements and the inferred statements but not the set of deleted explicit statements.

11. The method of claim 10, further comprising storing an output of executing forward-chaining inferences into the set of inferred statements to be deleted.

12. The method of claim 11, further comprising executing backward-chaining inferences using the set of inference rules to check whether a deleted explicit statement in the second temporary variable can still be computed from the explicit statements and the inferred statements.

13. The method of claim 12, further comprising substituting values of a subject, predicate, and object of the deleted explicit statement in the second temporary variable into heads of the set of inference rules and bodies of the set of inference rules, to produce a query.

14. The method of claim 13, further comprising causing the query to be submitted to a query answering process in which input statements can be chosen from the explicit statements and the inferred statements, but not the set of deleted explicit statements.

15. The method of claim 14, further comprising testing whether the deleted explicit statement in the second temporary variable can be computed from the explicit statements and the inferred statements, and removing the deleted explicit statement in the second temporary variable if the testing is affirmative.

16. The method of claim 15, further comprising copying the contents of the second temporary variable into the first temporary variable.

17. The method of claim 16, further comprising repeating the method until each explicit statement and inferred statement has been visited by the method.

18. The method of claim 17, further comprising setting the set of inferred statements to be deleted to the contents of the first temporary variable without the set of deleted explicit statements.

19. The method of claim 18, further comprising terminating the method.

20. A computer-readable medium, which is non-transitory, having computer-executable instructions stored thereon for implementing a method for reason maintenance of an RDF database, comprising:
receiving explicit statements including a set of deleted explicit statements;
computing inferred statements from the explicit statements; and
finding a set of inferred statements to be deleted from the inferred statements to facilitate correctness of the inferred statements without using stored truth maintenance information.
